(19) United States
(12) Patent Application Publication
(10) Pub. No.: US 2020/0056258 A1
(43) Pub. Date: Feb. 20, 2020

(54) METHOD FOR PRODUCING STEEL SHEETS

(71) Applicant: voestalpine Stahl GmbH, Linz (AT)

(72) Inventors: Thomas HEBESBERGER, Pasching (AT); Dieter PAESOLD, Neuhofen (AT); Markus STÖGMÜLLER, Pasching (AT)

(21) Appl. No.: 16/486,602

(22) PCT Filed: Feb. 16, 2018
(86) PCT No.: PCT/EP2018/053883

§ 371 Date: Aug. 16, 2019

(30) Foreign Application Priority Data
Feb. 17, 2017 (DE) 102017103308.4

(51) Int. Cl. C21D 9/46; C22C 38/14; C22C 38/12; C22C 38/06; C22C 38/04; C22C 38/02; C22C 38/00; C21D 8/02; C21D 6/00; C23C 2/06; C23C 2/40; B32B 15/01; C22C 33/04

(52) U.S. Cl. CPC C21D 9/46; C22C 38/14; C22C 38/12; C22C 38/06; C22C 38/04; C22C 38/02; C22C 33/04; C21D 8/0205; C21D 6/008; C21D 6/005; C23C 2/06; C23C 2/40; B32B 15/013; C22C 38/002

(57) ABSTRACT

A method for producing steel sheets, in particular for body shell sheets of vehicles, in which a steel alloy of a desired composition is melted, poured, and then rolled into sheet form, the steel alloy being a bake-hardening steel (BH steel) and the steel sheet being annealed after the tolling and subsequently provided with a metallic anti-corrosion coating and then dressed, wherein in order to achieve a low Wsa value with the narrowest possible spread, a niobium content of >0.01% by weight, preferably >0.011% by weight, is added to the alloy.

### FIELD OF THE INVENTION

The present invention relates to a method for producing steel sheets with an improved visual quality after forming.

### BACKGROUND OF THE INVENTION

In order to further improve the visual appearance of automobiles when painted, it has been discovered that while adjusting the strip topography to improve the paint appearance is indeed important, it is not sufficient. Multiple parameters are important for a good visual appearance of the paint in the production of formed and painted sheets.

An essential index for a good paintability and a good paint appearance is the so-called wave surface arithmetic value (Wsa). The 17 Oct. 2013 article “Novel Sheet Galvanizing Gives Automotive Paint Mirror Finish” [Neuartige Blechverzinkung bringt Automobillack auf Hochglanz] published on www.blechnet.com states that a Wsa value of the sheets below 0.35 μm ensures a good paint appearance. First of all, the article says that a low Wsa value is an indication of a good paint appearance. The article goes on to say that because the Wsa value simultaneously correlates to the average roughness (Ra), this also influences the formability. According to the article, experience has shown that it is important to reduce the Wsa value of the sheets to below 0.35 μm, whereas in conventional sheets the Wsa does indeed lie above 0.5 μm, and to simultaneously provide enough lubrication pockets for the forming, which is successfully achieved by increasing the so-called peak count.

In this case, the focus is placed on using the skin-pass roll to anticipate the subsequent topography of the sheet as a negative allowance in a manner similar to the one used in printing technology. In order to achieve the above-mentioned Wsa values, new roll textures were produced and in addition, thermal processes in the furnace were improved.

A comparable report has been published by thyssenkrupp Steel Europe at www.besserlackieren.de, which likewise includes a description that the surface finishing of the galvanized sheet makes it possible to achieve a corresponding quality.

EP 0 234 698 B1, for example, has disclosed a method in which a surface roughness with defined raised areas is produced.

DE 112014000102 T5 has disclosed a method that is intended to reduce the undulation of automobile parts by means of special nozzle settings.

Austrian standard EN10346 has disclosed continuously hot-dip refined articles made of steel for cold forming; this standard relates to the known coatings zinc, zinc/iron, zinc/aluminum, zinc/magnesium, aluminum/zinc, and aluminum/silicon.

The steels mentioned therein are all low-alloyed steels and in particular, multi-phase steels, TRIP steels, complex-phase steels, and ferritic-bainitic steels.

Particularly in the automotive sector, IF and BH steels are used in the body shell.

An IF steel is understood to be an “interstitial free” steel that does not have any interstitially embedded foreign atoms (the low quantities of carbon and nitrogen are completely segregated as carbides and nitrides by means of titanium and/or niobium) and therefore has an outstanding plastic deformability. Such steels are used for deep-drawn components in automotive engineering.

Bake-hardening steels (BH steels) feature a significant increase in the yield strength as part of the paint baking (typically at 170° C. for 20 min) in combination with a very good deformability. These steels also have a very good dent resistance, which is why these steels are often used for body shell applications.

The object of the invention is to create a method for producing steel sheers with which the desired Wsa values in the deformed state are better achieved and the ranges can be reliably maintained.

The measurement of the Wsa values was performed on Marciniak stretch-drawing specimens with 5% deformation, using SEP1941, but in the rolling direction.

### SUMMARY OF THE INVENTION

According to the invention, it has been determined that just by optimizing the long undulation in the non-deformed state, it is not possible to reliably and definitely keep the Wsa value of body shell components in the deformed state within the desired range of <0.35 μm.

According to the invention, it has been determined that the required long undulation limits in the deformed state can be definitely respected by performing selective steps on the material.

In other words, especially by changing the alloy composition in the IF and BH steels used, it is possible to achieve a more reliable production of body shell materials with reduced long undulation in the deformed state.

Correspondingly, it has been determined according to the invention that an ensured adjustment of reduced long undulation in the deformed stale can be achieved particularly in IF steels and bake-hardening steels by adding niobium to the alloy in percentages of >0.01% by weight. In particular, for example, the steel type HX180BD can be stabilized with a Wsa value at a level of below 0.30 μm.

When using IF steels, if instead of the usual titanium concept for body shell sheets, a titanium-niobium concept is used, then the Wsa level can be stabilized to an average of 0.27 μm.

As has been possible to determine according to the invention, when suitable skin-pass rolls are selected, the long undulation in the deformed state is not significantly influenced by the long undulation that is set before the dressing procedure during the stripping procedure.

It has also turned out to be advantageous that with the addition of Nb to the steel, the heating rates in the recrystallization annealing can be varied within a broad range without negatively influencing the Wsa value. The heating rates are between 8 and 30 K/s.

The dressing or temper-rolling procedure is used to adjust the mechanical properties and to selectively influence the surface roughness. In the course of this procedure, both the roughness and the long undulation are transmitted from the roll to the strip.

For BH steels, the degree of dressing for adjusting the required mechanical properties is greater than or equal to 1%, preferably greater than 1.1%.

### BRIEF DESCRIPTION OF THE DRAWINGS

The invention will be explained by way of example based on several drawings. In the drawings:

FIG. 1: shows the Wsa values in the non-deformed and deformed states in dressed bake-hardening steel material from the prior art.

FIG. 2: shows the comparison of the long undulation in dressed bake-hardening steel according to the prior art (through example 86) versus the Wsa values that are improved according to the invention, respectively before and after deformation (examples 87 through 184).

FIG. 3: shows the relationship between the niobium content in the base material (dressed BH steel) and the measured Wsa values in the deformed state.

FIG. 4: shows the Wsa value as a function of the deformation and the stripping medium used in the hot-dip coating process.

FIG. 5: shows the improvement of Wsa values through the addition of niobium to the alloy.

FIG. 6: shows a graph depicting the Wsa value plotted over the niobium content in the deformed state of a dressed IF steel.

FIG. 7: shows three composition ranges for IF and ULC-BH steels according to the invention.

FIGS. 8-13: show IF and BH steels according to the invention.

FIG. 14: shows examples with IF steels with a zinc coating.

FIG. 15: shows examples with BH steels with a zinc coating.

FIG. 16: shows other examples for IF steels with a metallic coating composed of ZnMg.

FIG. 17: shows other examples for BH steels with a metallic coating composed of ZnMg.

### DETAILED DESCRIPTION OF THE PREFERRED EMBODIMENTS

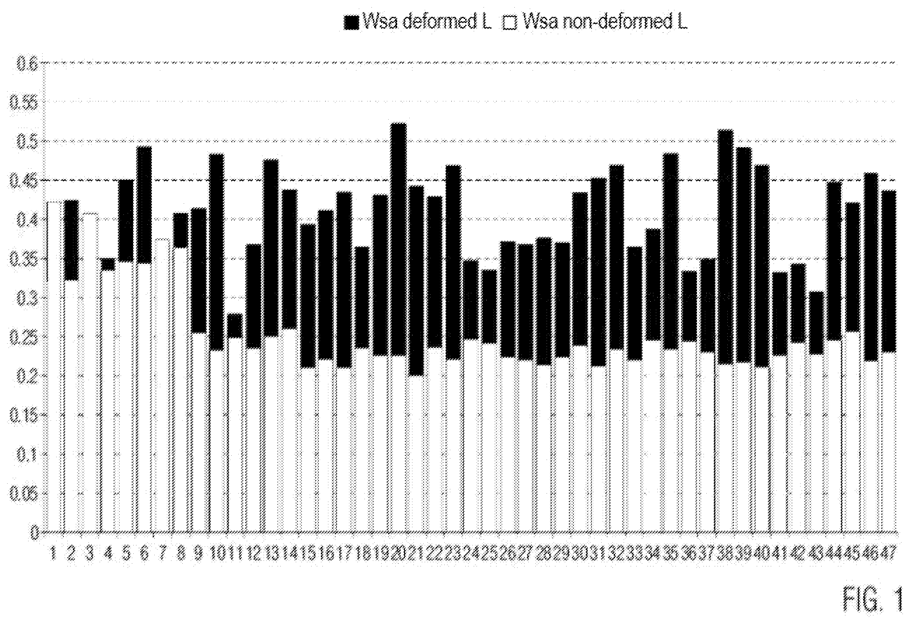

FIG. 1 shows a conventional bake-hardening steel, which has been produced and processed according to the prior art. In this case, the light-colored bars are the Wsa values for the non-deformed state and the black bars are the values for the deformed state. An improvement in the Wsa values in the non-deformed state that is achieved by optimizing the dressing procedure is not reflected in the Wsa values in the deformed state.

It is clear that there is a quite significant variation range in the deformed Wsa values. At the same time, there is a significant increase in the Wsa values in the course of the deformation. This extremely broad spread of values, which were determined longitudinal to the rolling direction in Marciniak specimens with five percent deformation, demonstrates that it is hardly possible to control the Wsa value according to the prior art.

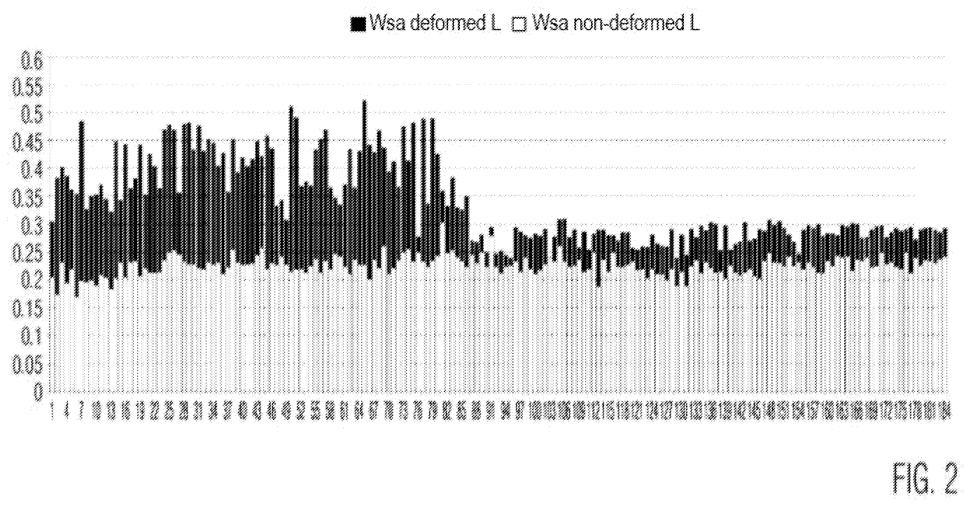

FIG. 2 shows this significant spread in the Wsa values; once again, the deformed values through example 86 show an even more pronounced spread than the non-deformed values. These are examples of a bake-hardening steel according to the prior art.

Starting with example 87, they are a bake-hardening steel according to the invention. Whereas the non-deformed Wsa values have a spread that corresponds to the prior art, the advantageous, significantly improved Wsa values after the deformation are quite readily apparent. It is clear that with the invention, the values can be reliably kept at or below 0.30 μm.

According to the invention, a niobium content >0.01% by weight (=100 ppm) in the alloy is set. According to the invention, the niobium content is preferably set to 0.011 to 0.15% by weight, more preferably 0.011 to 0.10% by weight, and even more preferably 0.011 to 0.05% by weight. With these values, it is possible to achieve extremely good Wsa values.

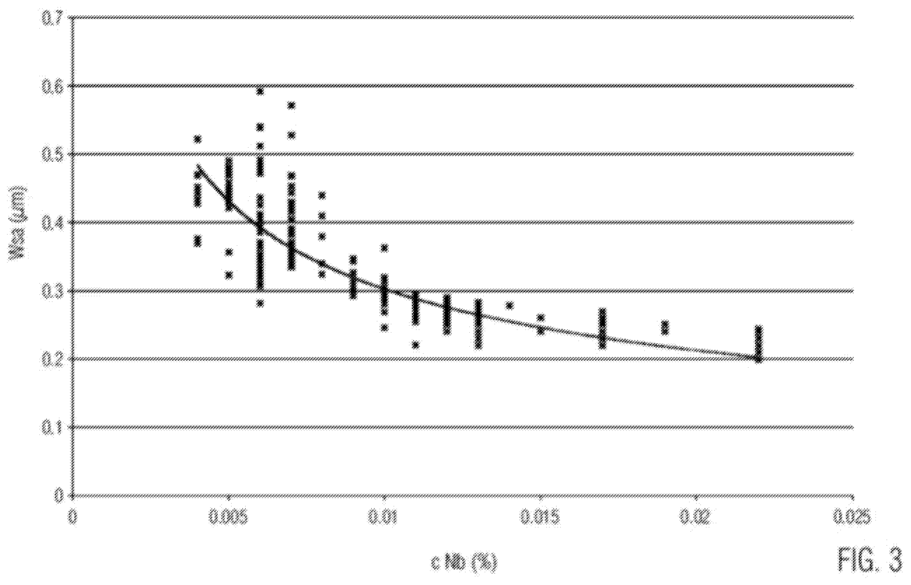

FIG. 3 shows the significant relationship between the Nb content in the BH steel and the Wsa level that occurs after forming (5%). With an increasing Nb content, not only does the Wsa value decrease, but there is also a significant drop in the spread.

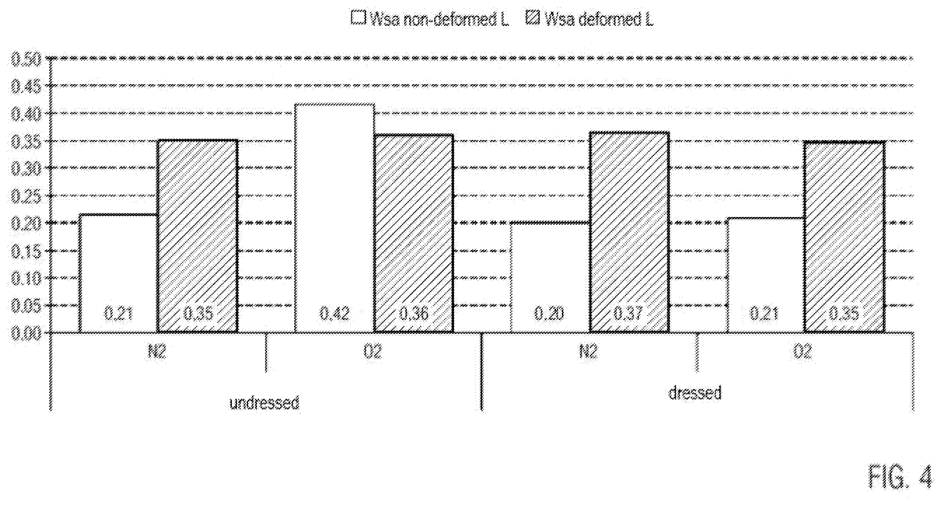

FIG. 4 shows that in the prior art, when using conventional IF steels with niobium contents of <0.002% by weight, the Wsa values in the undressed, non-deformed state depend on the stripping conditions during the application of a metallic coating according to the Sendzimir process. With nitrogen as a stripping medium, considerably lower values can be achieved. This advantage that is achieved by the stripping with nitrogen is no longer present after the deformation.

Through the use of suitable skin-pass rolls, it is possible to reduce the undulation values of the metallically coated strip in the non-deformed state to a low level regardless of the stripping medium. This improvement is no longer present, however, in the deformed state.

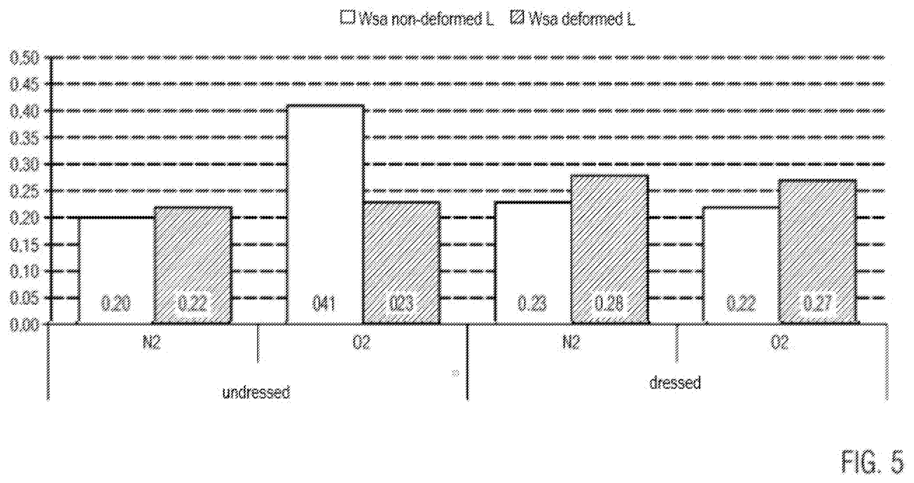

In a comparison test, the long undulation in an IF steel with a niobium content according to the invention of 0.015% by weight (FIG. 5) is likewise respectively measured in the undressed and dressed states; in this case, a coating according to the Sendzimir process is present and has been stripped once with nitrogen and once with air.

Through the addition of Nb, it was possible to achieve the fact that little or no increase in the Wsa values occurred due to the deformation.

Particularly after the deformation, the IF steels produced according to the invention exhibit considerably better properties than conventional IF steels according to the prior art.

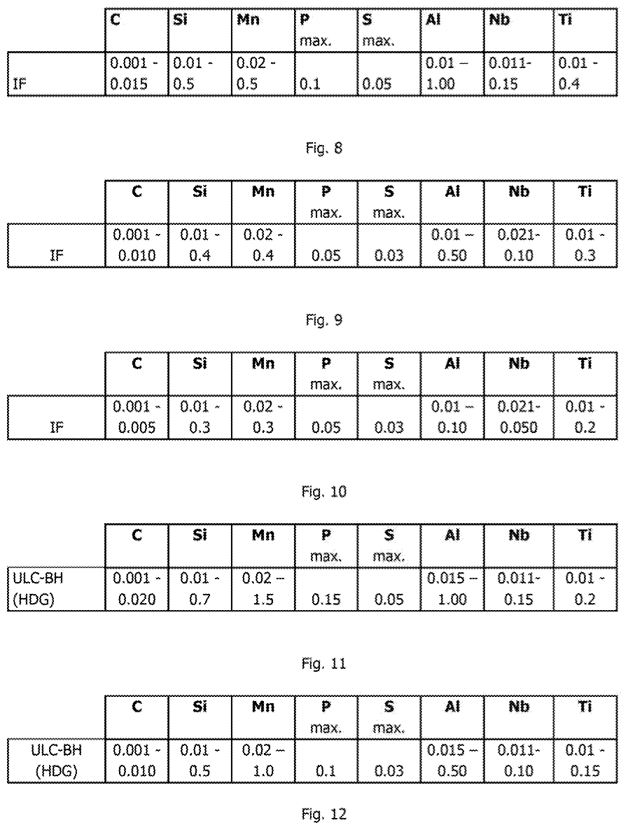

According to the invention, the IF steel can have the alloy composition shown in FIGS. 8, 9, and 10 (all values in percent by weight).

Alternatively with the composition according to FIG. 8, instead of niobium and also in combination with it,
between 0.01 and 0.15% by weight vanadium,
between 0.01 and 0.3% by weight zirconium,
between 0.02 and 0.5% by weight hafnium,
between 0.02 and 0.5% by weight tungsten, or
between 0.02 and 0.5% by weight tantalum can also be added to the alloy.

Preferably, the IF steel has the composition according to FIG. 9:

Alternatively with the composition according to FIG. 9, instead of niobium and also in combination with it,
between 0.01 and 0.12% by weight vanadium,
between 0.01 and 0.25% by weight zirconium,
between 0.02 and 0.4% by weight hafnium,
between 0.02 and 0.4% by weight tungsten, or
between 0.02 and 0.4% by weight tantalum can also be added to the alloy.

A particularly preferred composition of the IF steel is shown in FIG. 10, in which alternatively, instead of niobium and also in combination with it,
between 0.01 and 0.10% by weight vanadium,
between 0.01 and 0.2% by weight zirconium,
between 0.02 and 0.3% by weight hafnium,
between 0.02 and 0.3% by weight tungsten, or
between 0.02 and 0.3% by weight tantalum can also be added to the alloy.

The remainder is respectively composed of iron and smelting-dictated impurities.

The above-mentioned elements can be added to the alloy individually or in a combination of several of these elements, for example 0.02% by weight hafnium and tungsten, respectively.

According to the invention, the BH steel can have the alloy composition according to FIG. 11 (all values in percent by weight) in which alternatively, instead of niobium and also in combination with it,
between 0.01 and 0.15% by weight vanadium,
between 0.01 and 0.3% by weight zirconium.
between 0.02 and 0.5% by weight hafnium,
between 0.02 and 0.5% by weight tungsten, or
between 0.02 and 0.5% by weight tantalum can also be added to the alloy.

Preferably, the BH steel has the composition according to FIG. 12, in which alternatively, instead of niobium and also in combination with it,
between 0.01 and 0.12% by weight vanadium,
between 0.01 and 0.25% by weight zirconium,
between 0.02 and 0.4% by weight hafnium,
between 0.02 and 0.4% by weight tungsten, or
between 0.02 and 0.4% by weight tantalum can also be added to the alloy.

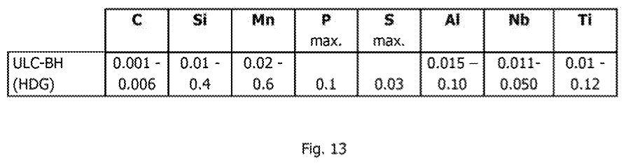

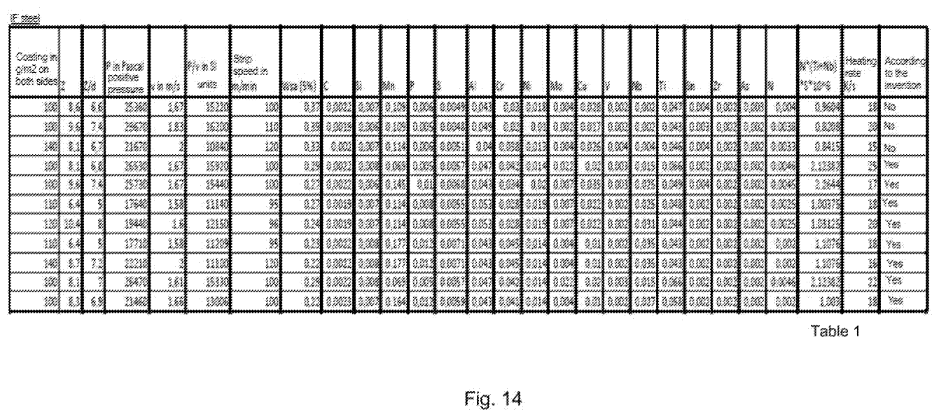

Preferably, the BH steel has the composition according to FIG. 13, in which alternatively, instead of niobium and also in combination with it.
between 0.01 and 0.10% by weight vanadium,
between 0.01 and 0.2% by weight zirconium,
between 0.02 and 0.3% by weight hafnium,
between 0.02 and 0.3% by weight tungsten, or
between 0.02 and 0.3% by weight tantalum can also be added to the alloy.
   The remainder is respectively composed of iron and smelting-dictated impurities.

Here, too, the elements can be added to the alloy individually or in combination, with the quantity in the respective ranges being determined stoichiometrically.

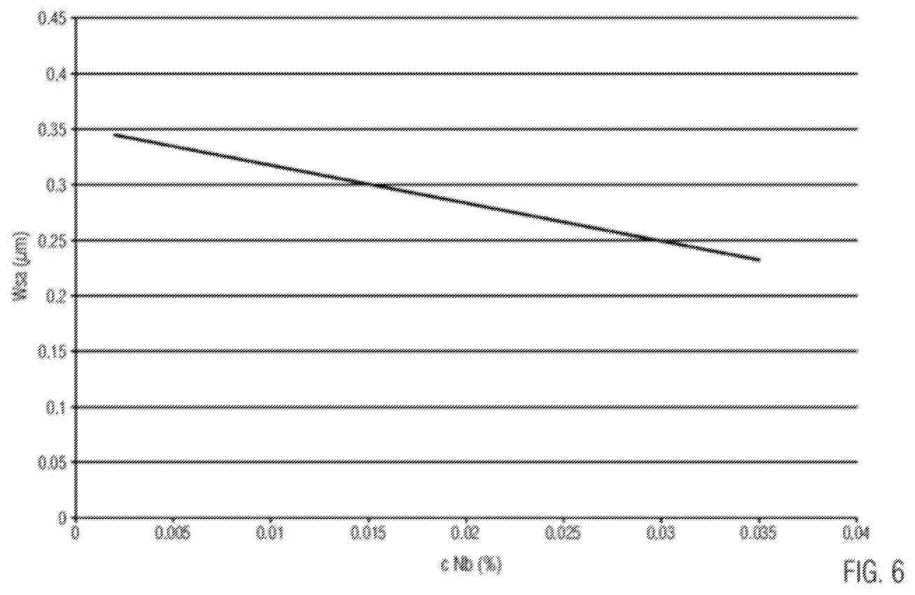

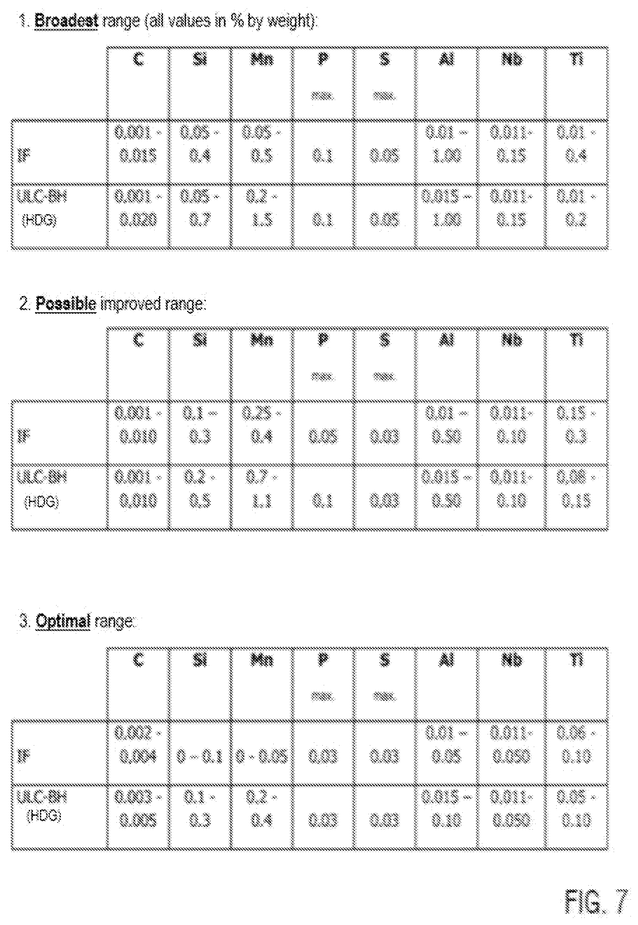

FIG. 6 shows the corresponding measured relationship in the IF steel, which indicates the Wsa values after deformation plotted over the niobium content. In this case, a steady improvement of the Wsa value is apparent as the Nb content increases. This relationship presumably also exists in additions of niobium to the alloy beyond 0.04% by weight. But the ranges according to the invention on the one hand permit a sufficient reduction of the Wsa value and on the other hand, prevent unwanted hardening effects in the base material, which would lead to a reduction in the deformability.

For a low long undulation in the non-deformed state and subsequently in the deformed state, the roll roughness (Ra) for the dressing procedure is set to values of between 1.6 and 3.3 μm in order to be able to maintain the roughness values in the strip that are required by the customer. A further reduction of the Wsa values is possible by reducing roll roughness values, but would require a reduction of the customer's roughness specifications.

In hot-dip galvanization applications, suitable coating materials particularly include all hot-dip galvanization baths.

For coating IF steels or also bake-hardening steels, it is particularly suitable to use a zinc/magnesium coating, with the zinc bath containing 0.2 to 8.0% by weight magnesium.

Instead of magnesium, it is also possible to use aluminum in the melt and it is likewise possible to also use magnesium and aluminum within the indicated limits of 0.2 to 8% by weight.

In a mix, the range is preferably 2% by weight magnesium and 2% by weight aluminum or 2.5% by weight aluminum and 1.5% by weight magnesium.

In the context of the application, coatings are metallic coatings.

In the invention, it is advantageous that by taking steps within the alloy concept in the steel, it is possible to successfully set the Wsa value to a very low level in a very stable way.

The following examples should demonstrate the positive influence of the niobium content on the formation of the Wsa value level in the formed component (measured in Marciniak specimens with 5% deformation) and should differentiate it from other influences.

In the examples for the coating variants Z and ZM listed below, strip speeds and nozzle settings have also been indicated for the sake of completeness. They all lie within the parameters that are customary according to the prior art, but have no significant influence on the Wsa values in the deformed state. The stripping was performed exclusively with nitrogen because otherwise, the visual impression of the sheets could not be produced to the customers' satisfaction.

The following tables show both the stripping parameters and the corresponding undulation values with a conventional zinc coating, for example after a hot-dip galvanization.

Z is the distance between the strip and the stripping nozzle along the stripping media outlet point and d is the average height of the outlet point of the nozzle above the zinc bath; both are indicated in mm.

v corresponds to the strip speed in m/s.

The alloy composition shows the respective alloy elements in percentage by weight.

Primarily, the examples in the table make it clear that the nozzle parameters have hardly any influence on the undulation values since both the exemplary embodiments according to the invention and those not according to the invention were produced with similar nozzle parameters.

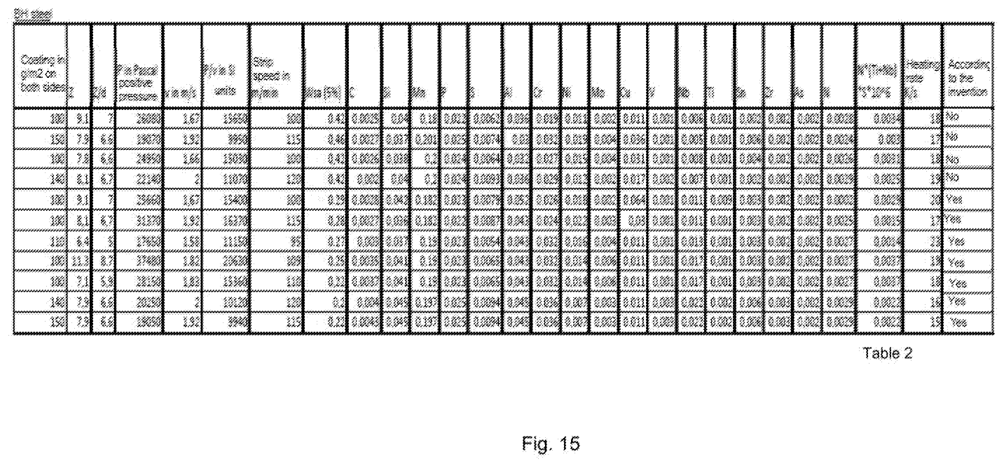

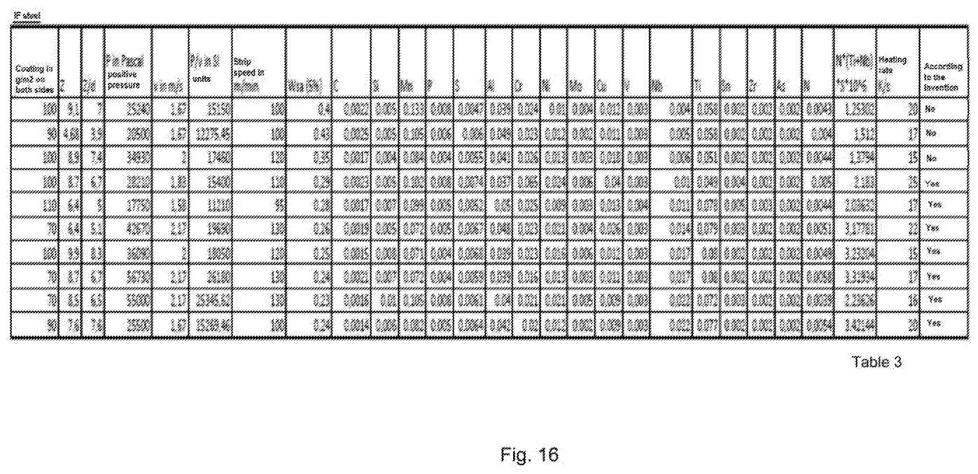

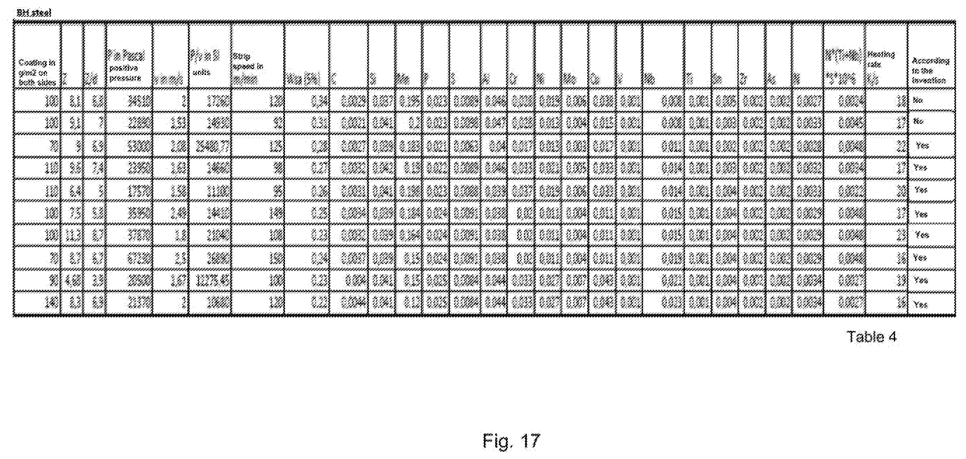

As shown by the examples in Table 3 (which corresponds to FIG. 16) and Table 4 (which corresponds to FIG. 17) with a ZnMg coating on IF and BH steels, starting from a Nb content of 0.01% by weight, the Wsa value in the deformed state can be reliably kept at or below 0.3 μm. As the Nb content increases, the Wsa value that can be achieved in the deformed state decreases further so that starting from 0.02% by weight of Nb, values below 0.25 μm can reliably be achieved. This applies only with the proviso that the Wsa values in the non-deformed state are not higher than the values indicated here.

It is also clear here that the nozzle setting has no significant influence on the undulation.

Z is the distance between the strip and the stripping nozzle along the stripping media outlet point and d is the average height of the outlet point of the nozzle above the zinc bath; both are indicated in mm.

v corresponds to the strip speed in m/s.

With the ZM coating, respectively with 1.5% by weight Mg and 2.5% by weight Al.

All of the alloy contents are indicated in % by weight unless explicitly indicated otherwise.

1. A method for producing steel sheets, in particular for body shell sheets of vehicles, comprising:
melting a bake-hardening steel (BH steel) alloy of a desired composition;
adding a niobium content of >0.01% by weight to the steel alloy in order to achieve a low Wsa value with a narrowest possible spread;
pouring the steel alloy, and rolling the steel alloy into sheet form;
annealing the steel sheet after the rolling, and subsequently providing the steel sheet with a metallic anti-corrosion coating and then dressing the steel sheet.

2. The method according to claim 1, wherein the BH steel is a ULC-BH steel with the following analysis in % by weight:

| | |
|---|---|
| C | 0.001 to 0.020 |
| Si | 0.01 to 0.7 |
| Mn | 0.02 to 1.5 |
| P | max. 0.15 |
| S | max. 0.05 |
| Al | 0.015 to 1.0 |
| Nb | 0.011 to 0.15 |
| Ti | 0.01 to 0.2 |

optionally containing one or more of the following elements:
up to max. 100 ppm boron and/or
up to 0.4% by weight vanadium and/or
up to 0.4% by weight zirconium;
a remainder composed of iron and smelting-dictated impurities.

3. The method according to claim 1, a wherein the BH steel is a ULC-BH steel with the following analysis in % by weight:

| | |
|---|---|
| C | 0.001 to 0.020 |
| Si | 0.01 to 0.7 |
| Mn | 0.02 to 1.5 |
| P | max. 0.15 |
| S | max. 0.05 |
| Al | 0.015 to 1.0 |
| Nb | 0.01 to 0.15 |
| Ti | 0.01 to 0.2 |

optionally containing one or more of the following elements:
up to max. 100 ppm boron and/or
up to 0.4% by weight vanadium and/or
up to 0.4% by weight zirconium, and or
up to 0.5% by weight hafnium, and/or
up to 0.5% by weight tungsten, and/or
up to 0.5% by weight tantalum;
a remainder composed of iron and smelting-dictated impurities.

4. The method according to claim 1, comprising applying the metallic anti-corrosion coating to the steel sheet while molten, wherein the coating is selected from the group consisting of: a zinc coating, a zinc-magnesium coating, a zinc-aluminum coating, a zinc-aluminum-magnesium coating, and aluminum-zinc coating, and an aluminum-silicon coating.

5. The method according to claim 4, wherein the coating, in addition to zinc, contains 0.2-8% by weight magnesium and/or aluminum.

6. The method according to claim 5, wherein the coating contains 2-2.5% by weight aluminum and 1.5-2% by weight magnesium.

7. The method according to claim 1, comprising using skin-pass rolls with a roughness (Ra) of 1.6 to 3.3 μm.

8. The method according to claim 1, wherein a degree of dressing is greater than or equal to 0.9%.

9. The method according to claim 1, comprising annealing the steel sheet at a heating rate between 8 K/s and 30 K/s.

10. A steel sheet produced according to the method of claim 2.

11. A method of using the steel sheet according to claim 10, comprising using the steel sheet to form body shell components of motor vehicles and/or buildings.

12. A steel sheet produced according to the method of claim 3.

13. A method of using the steel sheet according to claim 12, comprising using the steel sheet to form body shell components of motor vehicles and/or buildings.
